(19) United States
(12) Patent Application Publication
(10) Pub. No.: US 2006/0158094 A1
(43) Pub. Date: Jul. 20, 2006

(54) Field emission display (FED)

(76) Inventors: Jung-Woo Kim, Yongin-si (KR); Byong-Gwon Song, Seoul (KR); Jeong-Na Heo, Yongin-si (KR)

Correspondence Address: Robert E. Bushnell, Suite 300, 1522 K Street, N.W., Washington, DC, 20005-1202, US

(21) Appl. No.: 11/274,194

(22) Filed: Nov. 16, 2005

(30) Foreign Application Priority Data
Jan. 19, 2005 (KR) 10-2005-0005025

(51) Int. Cl. H01J 63/04

(52) U.S. Cl. 313/497

(57) ABSTRACT

A Field Emission Display (FED) using an electromagnetic field includes: a lower substrate and an upper substrate, spaced apart from each other and facing each other; cathode electrodes arranged on the lower substrate; gate electrodes arranged between the cathode electrodes; an anode electrode arranged on the upper substrate; a phosphor layer arranged on the anode electrode; and a gate driving circuit adapted to supply a current to the gate electrode to form an electromagnetic field around the gate electrode.

### CLAIM OF PRIORITY

This application makes reference to, incorporates the same herein, and claims all benefits accruing under 35 U.S.C. §119 from an application for FIELD EMISSION DISPLAY USING ELECTROMAGNETIC FIELD AND METHOD OF DRIVING THE FIELD EMISSION DISPLAY earlier filled in the Korean Intellectual Property Office on 19 Jan. 2005 and there duly assigned Ser. No. 10-2005-0005025.

### BACKGROUND OF THE INVENTION

1. Field of the Invention

The present invention relates to a Field Emission Display (FED), and more particularly, to an FED having improved brightness and luminous efficiency by focusing electrons emitted from an emitter using an electromagnetic field.

2. Description of the Related Art

A Field Emission Display (FED) is a display device which forms a strong electric field around an emitter formed on a cathode electrode, emits electrons from the emitter, accelerates the emitted electrons and collides the electrons with a phosphor layer coated on an anode electrode, thereby emitting light. Since an FED has a thickness of only several centimeters, a wide view angle, low power consumption and low manufacturing costs, FEDs have been selected as next-generation display devices together with Liquid Crystal Displays (LCDs) and a Plasma Display Panels (PDPs).

As a back-light device used in an LCD or the like, a Cold Cathode Fluorescent Lamp (CCFL) has been widely used as a filamentary light source and a Light Emitting Diode (LED) has been widely used as a point source of light. However, in general, the structure of the back-light device is complicated and manufacturing costs are high, and a high power consumption is caused by reflection and transmission of light. In addition, as the size of the LCD increases, it is difficult to obtain uniform brightness. As such, an FED for a back-light having a planar light-emitting structure has been developed. The FED for the back-light has a lower power consumption than that of a back-light using an existing CCFL and provides comparatively uniform brightness even in a wider light-emitting region.

An FED includes a lower substrate and an upper substrate are spaced apart from each other. The lower substrate and the upper substrate are maintained at a predetermined interval by a spacer formed therebetween. A cathode electrode is formed on an upper surface of the lower substrate, and an insulating layer and a gate electrode for extraction of electrons are sequentially formed on the cathode electrode. An emitter aperture through which the cathode electrode is exposed is formed in the insulating layer, and an emitter for emitting electrons is disposed inside the emitter aperture. An anode electrode is formed on a lower surface of the upper substrate, and a phosphor layer is coated on the anode electrode.

In the FED having the above structure, since electrons emitted from the emitter cannot reach a desired and correct position of the anode electrode, brightness and luminous efficiency are reduced. In order to emit more electrons from the emitter, a stronger electric field is supplied between the cathode electrode and the gate electrode, causing a leakage current between the cathode electrode and the gate electrode to increase.

### SUMMARY OF THE INVENTION

The present invention provides a Field Emission Display (FED) having improved brightness and luminous efficiency by focusing electrons emitted from an emitter using an electromagnetic field.

According to one aspect of the present invention, a Field Emission Display (FED) is provided including: a lower substrate and an upper substrate, spaced apart from each other and facing each other; a plurality of cathode electrodes arranged on the lower substrate; a plurality of gate electrodes arranged between the plurality of cathode electrodes; an anode electrode arranged on the upper substrate; a phosphor layer arranged on the anode electrode; and a gate driving circuit adapted to supply a current to the gate electrode to form an electromagnetic field around the gate electrode.

The gate driving circuit preferably includes either a resonant circuit or an energy recovery circuit.

The FED preferably further includes at least one emitter arranged on either side of the cathode electrode.

Each emitter preferably includes at least one material selected from the group consisting of carbon nanotubes (CNTs), amorphous carbon, nano-diamonds, nano-metallic lines, and nano-oxide-metallic-lines.

The cathode electrode and the gate electrodes are preferably stripe shaped. The cathode electrode and the gate electrodes are preferably arranged on a same plane of the lower substrate.

The gate driving circuit is preferably adapted to supply either a Direct Current (DC) or an Alternating Current (AC) to the gate electrode. The gate driving circuit is preferably adapted to control a magnitude of either the DC or AC supplied to the gate electrode to focus electrons emitted by the cathode electrode on a predetermined position of the anode electrode.

According to another aspect of the present invention, a Field Emission Display (FED) is provided including: a lower substrate and an upper substrate, spaced apart from each other and facing each other; a plurality of first and second cathode electrodes alternately arranged on the lower substrate; a gate electrode arranged between the first and second cathode electrodes; an anode electrode arranged on the upper substrate; a phosphor layer arranged on the anode electrode; and a gate driving circuit adapted to supply a current to the gate electrode to form an electromagnetic field around the gate electrode.

The gate electrode preferably includes a single body. The first and second cathode electrodes are preferably respectively connected to first and second cathode driving circuits. The gate driving circuit preferably includes either a resonant circuit or an energy recovery circuit.

The FED preferably further includes at least one emitter arranged on either side of the first and second cathode electrodes.

Each emitter preferably includes at least one material selected from the group consisting of carbon nanotubes (CNTs), amorphous carbon, nano-diamonds, nano-metallic lines, and nano-oxide-metallic-lines.

The first and second cathode electrodes are preferably stripe shaped. The first and second cathode electrodes and the gate electrode are preferably arranged on a same plane of the lower substrate.

The gate driving circuit is preferably adapted to supply an Alternating Current (AC) to the gate electrode.

The first and second cathode electrodes are preferably adapted to alternately emit electrons along a direction of the AC supplied to the gate electrode.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial cross-sectional view of an Field Emission Display (FED);

FIG. 2 is a partial cross-sectional view of an FED according to an embodiment of the present invention;

FIG. 3 is a plane view of a cathode electrode and a gate electrode arranged on a lower substrate of the FED of FIG. 2;

FIGS. 4A and 4B are respective views of a cathode electrode and a gate electrode when only a voltage is supplied to a gate electrode and when both a voltage and a current are supplied to the gate electrode;

FIGS. 5A and 5B are respective photos of an image formed on an upper substrate when only a voltage is supplied to a gate electrode and when both a voltage and a current are supplied to the gate electrode; and

FIG. 6 is a plane view of a cathode electrode and a gate electrode arranged on a lower substrate of an FED according to another embodiment of the present invention.

### DETAILED DESCRIPTION OF THE INVENTION

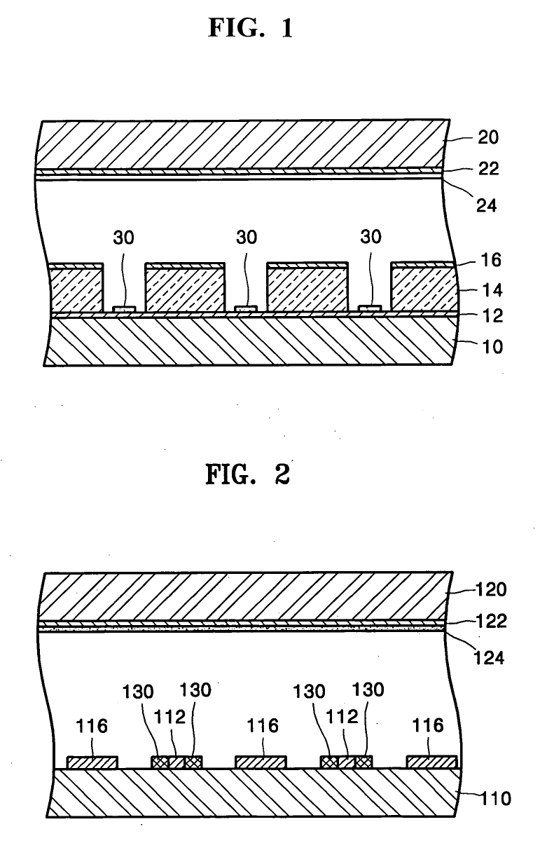

FIG. 1 is a partial cross-sectional view of an Field Emission Display (FED). Referring to FIG. 1, a lower substrate 10 and an upper substrate 20 are spaced apart from each other. The lower substrate 10 and the upper substrate 20 are maintained at a predetermined interval by a spacer (not shown) formed therebetween. A cathode electrode 12 is formed on an upper surface of the lower substrate 10, and an insulating layer 14 and a gate electrode 16 for extraction of electrons are sequentially formed on the cathode electrode 12. An emitter aperture through which the cathode electrode 12 is exposed is formed in the insulating layer 14, and an emitter 30 for emitting electrons is disposed inside the emitter aperture. An anode electrode 22 is formed on a lower surface of the upper substrate 20, and a phosphor layer 24 is coated on the anode electrode 22.

In the FED having the above structure, since electrons emitted from the emitter 30 cannot reach a desired and correct position of the anode electrode 22, brightness and luminous efficiency are reduced. In order to emit more electrons from the emitter 30, a stronger electric field is supplied between the cathode electrode 12 and the gate electrode 16, causing a leakage current between the cathode electrode 12 and the gate electrode 16 to increase.

Hereinafter, the present invention will be described in detail by explaining exemplary embodiments of the invention with reference to the attached drawings. Like reference numerals in the drawings denote like elements.

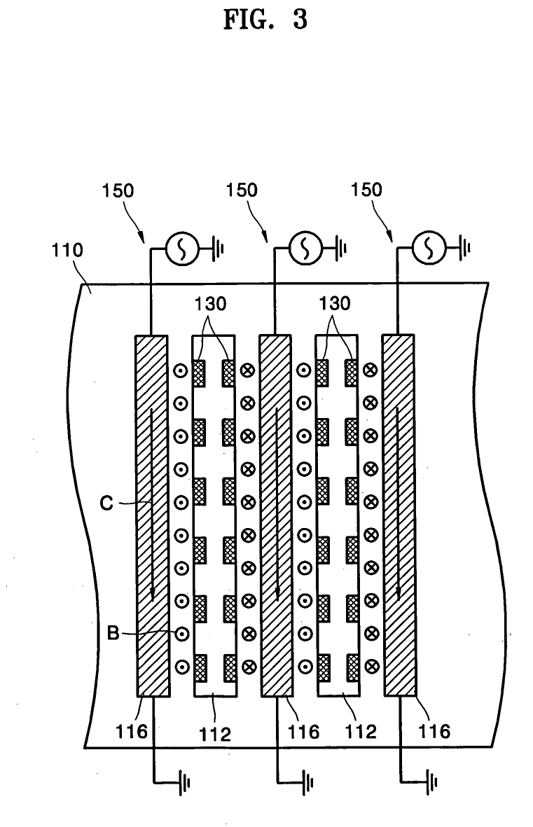

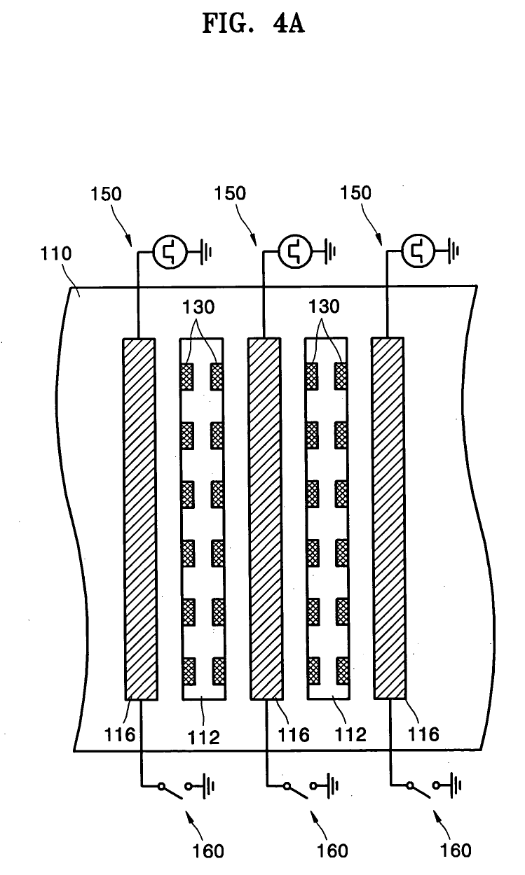

FIG. 2 is a partial cross-sectional view of an FED according to an embodiment of the present invention, and FIG. 3 is a plane view of a cathode electrode and a gate electrode, which are disposed on a lower substrate of the FED of FIG. 2. Referring to FIGS. 2 and 3, a lower substrate 110 and an upper substrate 120 are spaced apart from each other and face each other.

The lower substrate 110 and the upper substrate 120 are maintained at a predetermined interval by a spacer (not shown) disposed therebetween. An anode electrode 122 is disposed on a lower surface of the upper substrate 120, and a phosphor layer 124 is formed on a lower surface of the anode electrode 122.

A cathode electrode 112 and a gate electrode 116 are alternately formed on an upper surface of the lower substrate 110. The cathode electrode 112 and the gate electrode 116 can be formed in a stripe shape on the same plane of the lower substrate 110. At least one emitter 130 is disposed on either side of the cathode electrode 112. The emitter 130 is a source of emitted electrons due to an electric field supplied between the cathode electrode 112 and the gate electrode 116. The emitter 130 can be formed of at least one material selected from the group consisting of carbon nanotubes (CNTs), amorphous carbon, nano-diamonds, nano-metallic lines, and nano-oxide-metallic-lines.

A gate driving circuit 150 is connected to the gate electrode 116. The gate driving circuit 150 supplies a voltage to the gate electrode 116 and causes a current to flow through the gate electrode 116. The gate driving circuit 150 and the gate electrode 116 constitute a closed loop to allow the flow a current through the gate electrode 116. A Direct Current (DC) or an Alternating Current (AC) can be supplied to the gate electrode 116. When AC is supplied to the gate electrode 116, the gate driving circuit 150 can include a resonant circuit (not shown) or an energy recovery circuit (not shown), so as to minimize power consumption.

If the gate electrode 116 and the gate driving circuit 150 constitute a closed loop, a predetermined voltage difference exists between the ends of the gate electrode 116, and thus, a current C flows through the gate electrode 116. If the current C flows through the gate electrode 116, an electromagnetic field B is formed around the gate electrode 116.

In the above structure, if a predetermined voltage is supplied to the cathode electrode 112 and the gate electrode 116, respectively, electrons are emitted from the emitter 130 of the cathode electrode 112 by an electric field formed between the cathode electrode 112 and the gate electrode 116. Since the current C flows through the gate electrode 116, the electromagnetic field B is formed around the gate electrode 116, electrons emitted from the emitter 130 are affected by the electromagnetic field B, rotated in a spiral shape and accelerated toward the anode electrode 122. The current C that flows through the gate electrode 116 is controlled using the gate driving circuit 150 so that electrons emitted from the emitter 130 can be focused in a desired position of the anode electrode 122. The focused electrons collide with the phosphor layer 124 and produce a visible light.

If the current C flows through the gate electrode l16 using the gate driving circuit 150 in this way, electrons emitted from the emitter 130 by an electromagnetic field formed around the gate electrode 116 can be effectively focused in a desired position of the anode electrode 122. As such, brightness and uniformity of brightness can be improved and a luminous efficiency can be increased. Owing to a rotative force of the electrons emitted from the emitter 130, the luminous efficiency can be additionally increased.

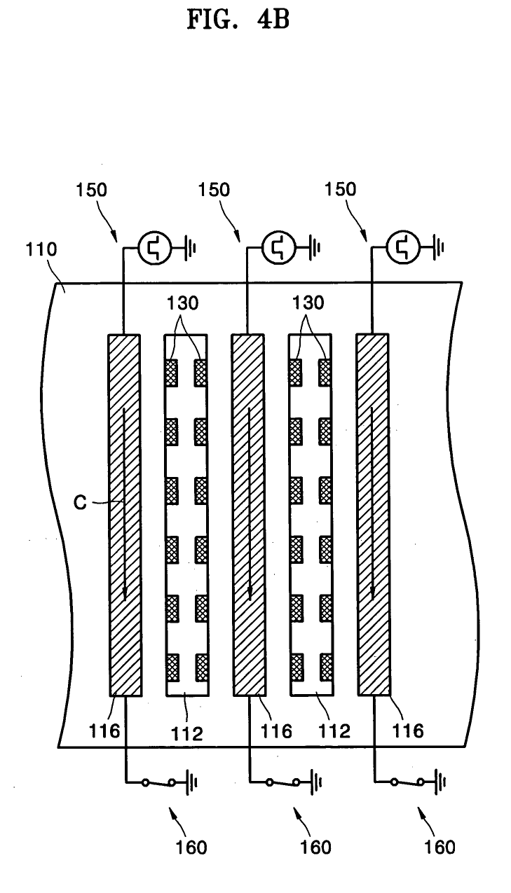

FIG. 4A is a view of an arrangement where a switch 160 connected to the gate driving circuit 150 is turned off and only a voltage is supplied to the gate electrode 116, and FIG. 4B is a view of an arrangement where the switch 160 connected to the gate driving circuit 150 is turned on and a voltage and a current are supplied to the gate electrode 116.

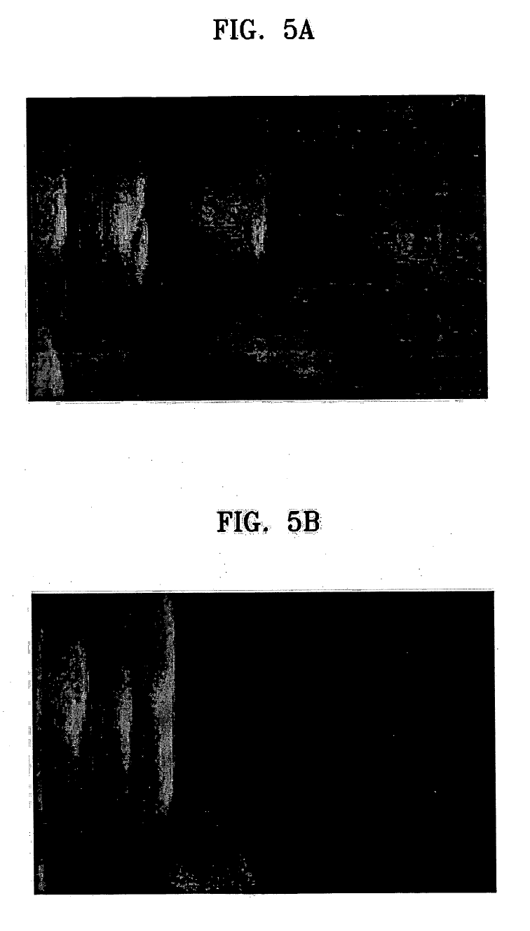

FIGS. 5A and 5B are respective photos of an image formed on an upper substrate when only a voltage is supplied to the gate electrode 116, as in FIG. 4A and when a voltage and a current are supplied to the gate electrode 116, as in FIG. 4B. Referring to FIGS. 5A and 5B, when only a voltage is supplied to the gate electrode 116, electrons emitted from the emitter 130 do not reach a desired position of the anode electrode 122 so that spreading of an image occurs, as shown in FIG. 5A. On the other hand, when a voltage and the current C are supplied to the gate electrode 116, the electrons emitted from the emitter 130 by the electromagnetic field formed around the gate electrode 116 are focused in a desired position of the anode electrode 122 so that spreading of an image is reduced, as shown in FIG. 5B.

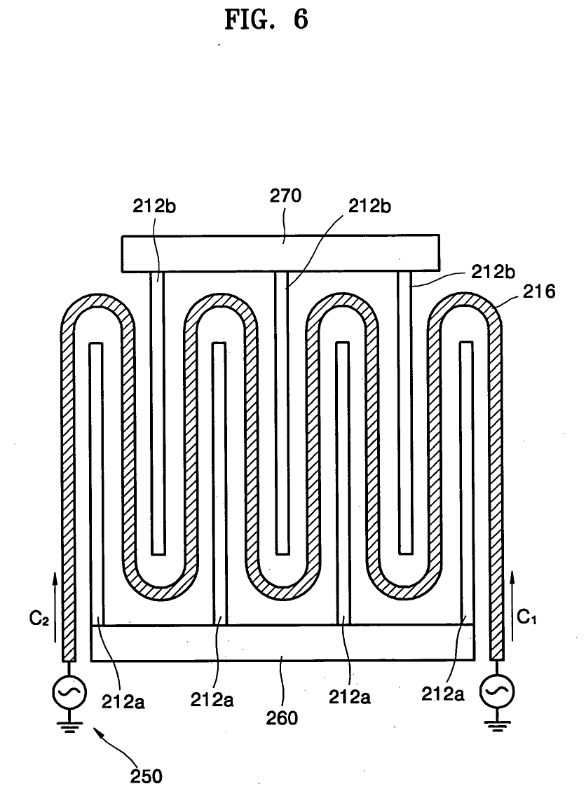

FIG. 6 is a plane view of a cathode electrode and a gate electrode, which are disposed on a lower substrate of an FED according to another embodiment of the present invention. In the present embodiment, the upper substrate and the lower substrate and the anode electrode and the phosphor layer formed on the upper substrate have been described in the above-described embodiment, and thus, a detailed description thereof has been omitted.

Referring to FIG. 6, cathode electrodes 212a and 212b and a gate electrode 216 are formed on a lower substrate (not shown). The cathode electrodes 212a and 212b and the gate electrode 216 can be formed on the same plane. The cathode electrodes 212a and 212b include a plurality of first cathode electrodes 212a and a plurality of second cathode electrodes 212b, which are disposed alternately on the lower substrate. The first and second cathode electrodes 212a and 212b can be formed in a stripe shape. At least one emitter (not shown) can be disposed on either side of the first and second cathode electrodes 212a and 212b. The emitter can be formed of at least one material selected from the group consisting of carbon nanotubes (CNTs), amorphous carbon, nano-diamonds, nano-metallic lines, and nano-oxide-metallic-lines.

The gate electrode 216 is arranged between the first cathode electrode 212a and the second cathode electrode 212b. The gate electrode 216 is formed of a single body. A first cathode driving circuit 260 is connected to the first cathode electrodes 212a, so as to supply a predetermined voltage to the first cathode electrodes 212a. A second cathode driving circuit 270 is connected to the second cathode electrodes 212b, so as to supply a predetermined voltage to the second cathode electrodes 212b.

A gate driving circuit 250 is connected to the gate electrode 216, so as to supply a voltage and a current to the gate electrode 216. The gate electrode 216 and the gate driving circuit 250 constitute a closed loop. If a current flows through the gate electrode 216 using the gate driving circuit 250, an electromagnetic field is formed around the gate electrode 216. In the present embodiment, AC is supplied to the gate electrode 216 using the gate driving circuit 250. The gate driving circuit 250 can include a resonant circuit (not shown) or an energy recovery circuit (not shown), so as to minimize power consumption.

In the above structure, if a predetermined voltage is supplied to the first cathode electrodes 212a and the gate electrode 216, respectively, using the first cathode driving circuit 260 and the gate driving circuit 250, a current flows through the gate electrode 216 in a direction of C1, for example. An electromagnetic field is formed around the gate electrode 216 according to the current that flows through the gate electrode 216 in the direction of C1. As such, owing to the electric field formed between the first cathode electrodes 212a and the gate electrode 216, electrons are emitted from the emitter of the first cathode electrodes 212a, and the emitted electrons are focused in a desired position of an anode electrode (not shown) by the electromagnetic field formed around the gate electrode 216. Next, a predetermined voltage is supplied to the second cathode electrodes 212b and the gate electrode 216, respectively, using the second cathode driving circuit 270 and the gate driving circuit 250. A current flows through the gate electrode 216 in a direction of C2 opposite to C1. Then, an electromagnetic field is formed around the gate electrode 216 according to the current that flows through the gate electrode 216 in the direction of C2. As such, owing to the electric field formed between the second cathode electrodes 212b and the gate electrode 216, electrons are emitted from the emitter of the second cathode electrodes 212b, and the emitted electrons are focused in a desired position of the anode electrode by the electromagnetic field formed around the gate electrode 216. In this way, in the present embodiment, since the direction of the current that flows through the gate electrode 216 is changed, electrons are emitted alternately from the first cathode electrodes 212a and the second cathode electrodes 212b.

As described above, in the field emission display (FED) according to the present invention, a gate driving circuit is provided to supply a voltage to a gate electrode and simultaneously cause a current to flow such that an electromagnetic field is formed around the gate electrode and electrons emitted from an emitter of a cathode electrode are effectively focused in a desired position of an anode electrode. As a result, brightness and uniformity of brightness are improved and a luminous efficiency is increased.

While the present invention has been particularly shown and described with reference to exemplary embodiments thereof, it will be understood by those skilled in the art that various modifications in form and detail can be made therein without departing from the spirit and scope of the invention as defined by the following claims.

What is claimed is:

1. A Field Emission Display (FED), comprising:
a lower substrate and an upper substrate, spaced apart from each other and facing each other;
a plurality of cathode electrodes arranged on the lower substrate;
a plurality of gate electrodes arranged between the plurality of cathode electrodes;
an anode electrode arranged on the upper substrate;
a phosphor layer arranged on the anode electrode; and
a gate driving circuit adapted to supply a current to the gate electrode to form an electromagnetic field around the gate electrode.

2. The FED of claim 1, wherein the gate driving circuit comprises either a resonant circuit or an energy recovery circuit.

3. The FED of claim 1, further comprising at least one emitter arranged on either side of the cathode electrode.

4. The FED of claim 3, wherein each emitter comprises at least one material selected from the group consisting of carbon nanotubes (CNTs), amorphous carbon, nano-diamonds, nano-metallic lines, and nano-oxide-metallic-lines.

5. The FED of claim 1, wherein the cathode electrode and the gate electrodes are stripe shaped.

6. The FED of claim 1, wherein the cathode electrode and the gate electrodes are arranged on a same plane of the lower substrate.

7. The FED of claim 1, wherein the gate driving circuit is adapted to supply either a Direct Current (DC) or an Alternating Current (AC) to the gate electrode.

8. The FED claim 7, wherein the gate driving circuit is adapted to control a magnitude of either the DC or AC supplied to the gate electrode to focus electrons emitted by the cathode electrode on a predetermined position of the anode electrode.

9. A Field Emission Display (FED), comprising:
a lower substrate and an upper substrate, spaced apart from each other and facing each other;
a plurality of first and second cathode electrodes alternately arranged on the lower substrate;
a gate electrode arranged between the first and second cathode electrodes;
an anode electrode arranged on the upper substrate;
a phosphor layer arranged on the anode electrode; and
a gate driving circuit adapted to supply a current to the gate electrode to form an electromagnetic field around the gate electrode.

10. The FED of claim 9, wherein the gate electrode comprises a single body.

11. The FED of claim 10, wherein the first and second cathode electrodes are respectively connected to first and second cathode driving circuits.

12. The FED of claim 11, wherein the gate driving circuit comprises either a resonant circuit or an energy recovery circuit.

13. The FED of claim 10, further comprising at least one emitter arranged on either side of the first and second cathode electrodes.

14. The FED of claim 13, wherein each emitter comprises at least one material selected from the group consisting of carbon nanotubes (CNTs), amorphous carbon, nano-diamonds, nano-metallic lines, and nano-oxide-metallic-lines.

15. The FED of claim 10, wherein the first and second cathode electrodes are stripe shaped.

16. The FED of claim 10, wherein the first and second cathode electrodes and the gate electrode are arranged on a same plane of the lower substrate.

17. The FED of claim 9, wherein the gate driving circuit is adapted to supply an Alternating Current (AC) to the gate electrode.

18. The FED of claim 17, wherein the first and second cathode electrodes are adapted to alternately emit electrons along a direction of the AC supplied to the gate electrode.
